(19) United States
(12) Patent Application Publication
(10) Pub. No.: US 2011/0022501 A1
(43) Pub. Date: Jan. 27, 2011

(54) SERVICE CHANGE COMPONENT GENERATION SYSTEM, METHOD AND RECORDING MEDIUM

(76) Inventor: Keiichi Iguchi, Tokyo (JP)

Correspondence Address: Mr. Jackson Chen, 6535 N. STATE HWY 161, IRVING, TX, 75039, US

(21) Appl. No.: 12/922,784

(22) PCT Filed: Apr. 15, 2009
(86) PCT No.: PCT/JP2009/057551

§ 371 Date: Sep. 15, 2010

(30) Foreign Application Priority Data
Apr. 16, 2008 (JP) 2008-107354

(51) Int. Cl. G06Q 10/00

(52) U.S. Cl. 705/28

(57) ABSTRACT

A service component change generation system is provided with a dependence relationship information creation means that, when service change information including information to specify a component to be changed out of a plurality of components is inputted, refers to a database that stores definitions of dependence relationships indicating the dependence relationships between the change of a component and the change of related components, and creates information of dependence relationships between components to be changed in the service; and a changing component set creation means that refers to the information of the dependence relationships, extracts components to be changed that are mutually related by the dependence relationships and creates a set of components to be changed.

### TECHNICAL FIELD

The present invention relates to a service change component generation system, method and recording medium, and more particularly to a service change component generation system for generating as components changes applied to a service (program) that includes a plurality of components, and a method and recording medium.

### BACKGROUND ART

Technology has been known from before for synthesizing components to create programs by extracting in advance the functional relationships among various components in the program or by the developer's defining such. Such a program creation system is disclosed in Patent Literature 1.

The program creation system disclosed in Patent Literature 1 reads the source code file of a program if the source code file exists, analyzes this and extracts component definitions from this. Conversely, when no source code file of the program exists, definitions indicating dependence relationships between a component and other components are recorded in a dictionary by the developer inputting interface information and the like. When the developer later creates a new program, the recorded components can be reused. At the time of this reuse, the developer creates a new program by combining a component and related components in accordance with the dependence relationships defined in the dictionary by reading out from the dictionary definitions indicating the dependence relationships between a component and other components.

### PRIOR ART LITERATURE

### Patent Literature

Patent Literature 1: Unexamined Japanese Patent Application KOKAI Publication No. H09-134282.

### DISCLOSURE OF INVENTION

### Problem Solved by the Invention

In related art such as Patent Literature 1, the types of dependence relationships between the component and other components were limited to whether an interface is used or not used. Consequently, it was impossible to decide whether or not changes inside the interface were changes that had an effect on reuse of the components. To state this in detail, when changes have been added to multiple components out of the recorded components, the developer (user) cannot determine what changes relating to a component need to be applied to other services. Consequently, when reusing changes applied to components, the user only had two choices; apply all changes relating to related components having a dependence relationship, or not apply any. Thus, in the related art, even when there is a service that includes changes considered necessary for other services, it was impossible to extract only the necessary parts of the changes from that service and to reuse that changed component in other services. Consequently, the related art had the problem that it was impossible to effectively utilize service change resources.

In addition, a service (program) is not necessarily composed only from program components, for non-program components such as “data,” “user input screen definitions” and “result output screen definitions” and the like may be included as constituent elements. These non-program components cannot necessarily define the same interface as program components. Consequently, the above-described related art had the problem that it was impossible to extract dependence relationships between program components and non-program components, making it impossible to apply service change resources to reuse of non-program components constituting a service.

The present invention was created in consideration of the foregoing, and it is an objective of the present invention to provide a service change component generation system, method and recording medium that can effectively utilize service change resources by enabling reuse in other services changes relating to all components having dependence relationships.

### SUMMARY OF THE INVENTION

A first aspect of the present invention provides a service change component generation system provided with a dependence relationship information creation unit that, when service change information including information specifying a component to be changed out of a plurality of components in inputted, creates dependence relationship information between components to be changed in a service by referring to a database storing dependence relationship definitions indicating dependence relationships between change of a component and change of related components; and a changing component set creation unit that refers to the dependence relationship information, extracts changing components mutually related by the dependence relationships and creates a changing components set.

A second aspect of the present invention provides a service change component generation method for inputting service change information including information specifying a component to be changed out of a plurality of components; creating information on dependence relationships among changing components in the service by referring to a database storing dependence relationship definitions showing dependence relationships between component changes and related component changes; and creating a changing component set by referring to the dependence relationship information and extracting changing components that are mutually related by the dependence relationships.

A third aspect of the present invention provides a recording medium for recording a program readable and writable by a computer, wherein this program causes the computer to execute a process for inputting service change information including information specifying a component to be changed out of a plurality of components; a process for creating information on dependence relationships among changing components in the service by referring to a database storing dependence relationship definitions showing dependence relationships between component changes and related component changes; and a process for creating a changing component set by referring to the dependence relationship information and extracting changing components that are mutually related by the dependence relationships.

### EFFICACY OF THE INVENTION

With the composition of the present invention, it is possible to obtain change set components for small constituent components whose services have changed, so it is possible to reuse change information and to effectively utilize service change resources. The dependence definition between components is preferably defined between component types for types of components of the same type. At the same time, the definition of change dependence is preferably defined between the change types for types with the same change.

The above and other objectives of the present invention, along with its characteristics and benefits, are explained in greater detail below with reference to the drawings.

### BRIEF DESCRIPTION OF DRAWINGS

FIG. 1 is a block diagram schematically showing the composition of a service change component generation system relating to a first embodiment of the present invention.

FIG. 2 is a block diagram showing an example of the details of a dependence definition database in the service change component generation system of FIG. 1.

FIG. 3 is a block diagram showing an example of the details of a change type database in the service change component generation system of FIG. 1.

FIG. 4 is a flowchart showing the sequence of operating processes of the service change component generation system of FIG. 1.

FIG. 5 is a flowchart showing the sequence of operating processes of the service change component generation system of FIG. 1.

FIG. 6 is a flowchart showing the sequence of operating processes of the service change component generation system of FIG. 1.

FIG. 7 is a block diagram conceptually showing the service definitions and service change information input into the dependence relationship information creation unit in the service change component generation system of FIG. 1.

FIG. 8 is a block diagram conceptually showing a dependence relationship information created by the dependence relationship information creation unit of FIG. 7.

FIG. 9 is a block diagram conceptually showing the change component sets created by a difference set creation unit in the service change component generation system of FIG. 1.

### BEST MODE FOR CARRYING OUT THE INVENTION

In its minimum composition, the service change component generation system of the present invention is provided with a dependence relationship information creation unit that, when service change information including information specifying a component to be changed out of a plurality of components in inputted, creates dependence relationship information between components to be changed in a service by referring to a database storing dependence relationship definitions indicating dependence relationships between change of a component and change of related components; and a changing component set creation unit that refers to the dependence relationship information, extracts changing components mutually related by the dependence relationships and creates a changing components set.

With the service change component generation system of the present invention, when there is a change of components in the service, a set of change components within the service is created by referring to a database defining the dependence relationships of changes among components, so that change component set can be used as a component.

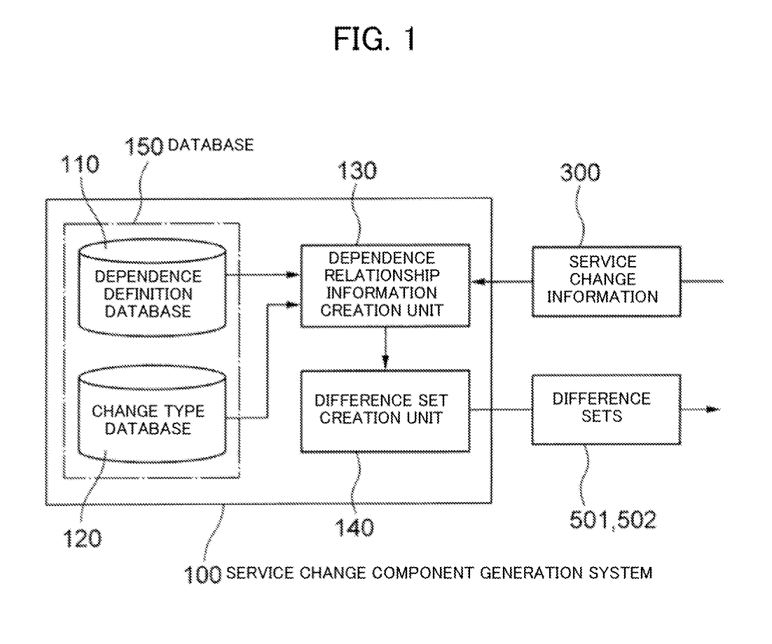

As below, a service change component creation system according to a first configuration of the present invention is described with reference to the drawings. FIG. 1 is a block diagram of the service change component creation system of this configuration. This service change component generation system 100 is used to componentize changes added to a service that includes multiple components.

The service change component generation system 100 is provided with a database 150 inside the system. This database 150 includes a dependence definition database 110 for storing dependence definitions defining dependence relationships for each type of component indicating upon which changes in related components changes in these components are dependent, and a change type database 120 for storing change information for each type of component indicating what kinds of changes are performed in these components.

The service change component generation system 100 is provided with a dependence relationship information creation unit 130 for creating dependence relationship information between the change difference of a component and the change difference of related components on the basis of input service change information 300 and the dependence definitions stored in the dependence definition database 110, and a difference set creation unit 140 for referring to the dependence relationship information, extracting a plurality of change differences linked by dependence relationships in content that needs to be simultaneously or collectedly applied, and creates a change component set with these as the set. The service change information 300 includes service specification information including the application of the service, information specifying which of the plurality of components in the service have changed, and information on the change differences of those changed components. This configuration illustrates a case in which the service change information 300 is input by a user such as a developer, but it would also be fine to extract change components and change differences from a source program indicating the pre-change service and a source program indicating the post-change service.

The service change component generation system 100 of the present configuration compiles, for each component type, dependence relationships related to changes among service components with respect to change information related to the plurality of components that comprise the service, and finds the dependence relationships in units of change information. Consequently, it is possible to compile and extract only the change differences in dependence relationships, to compile only change differences that need to be simultaneously or collectedly applied, and to set the components used in service changes as a minimum difference set. Through this, it is possible to reuse change differences by obtaining the change component set for small compositions, and as a result it is possible to effectively utilize service change resources.

With the above composition, the change type dependent information between related component types is stored for each component type, so it is possible to define dependence relationships without regard to whether these are program components or non-program components. Consequently, it is possible to reuse change differences for non-program components that comprise the service, making it possible to effectively utilize service change resources.

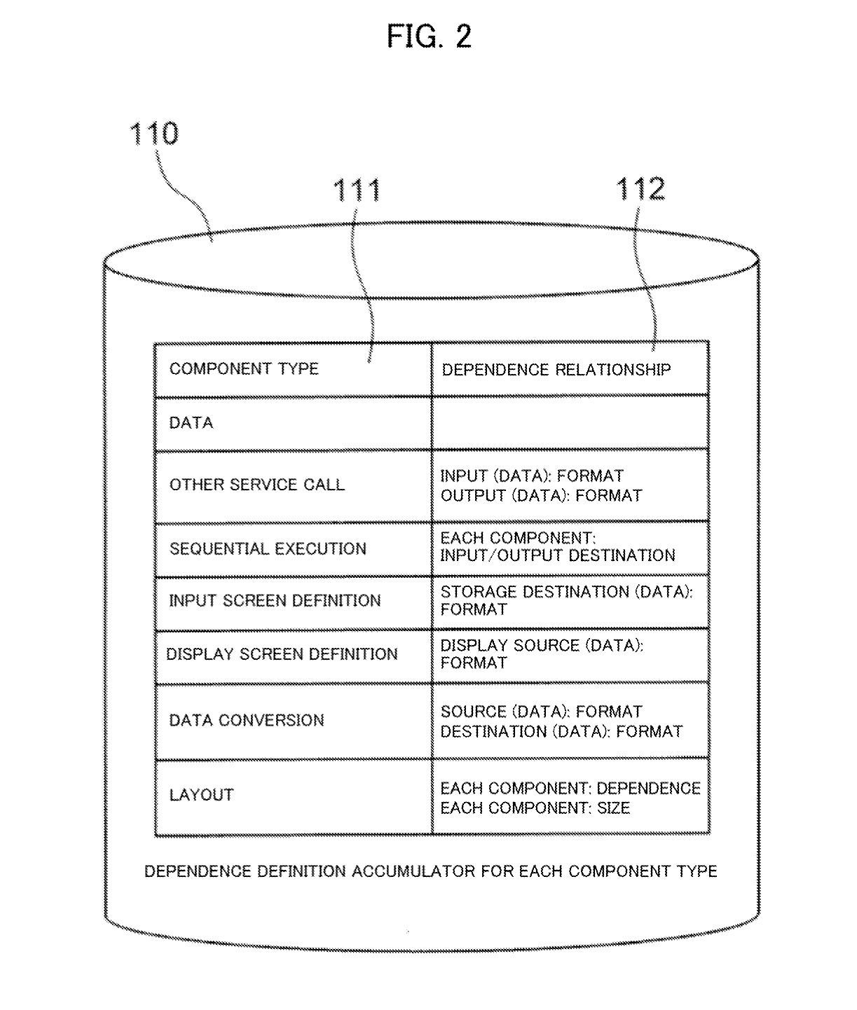

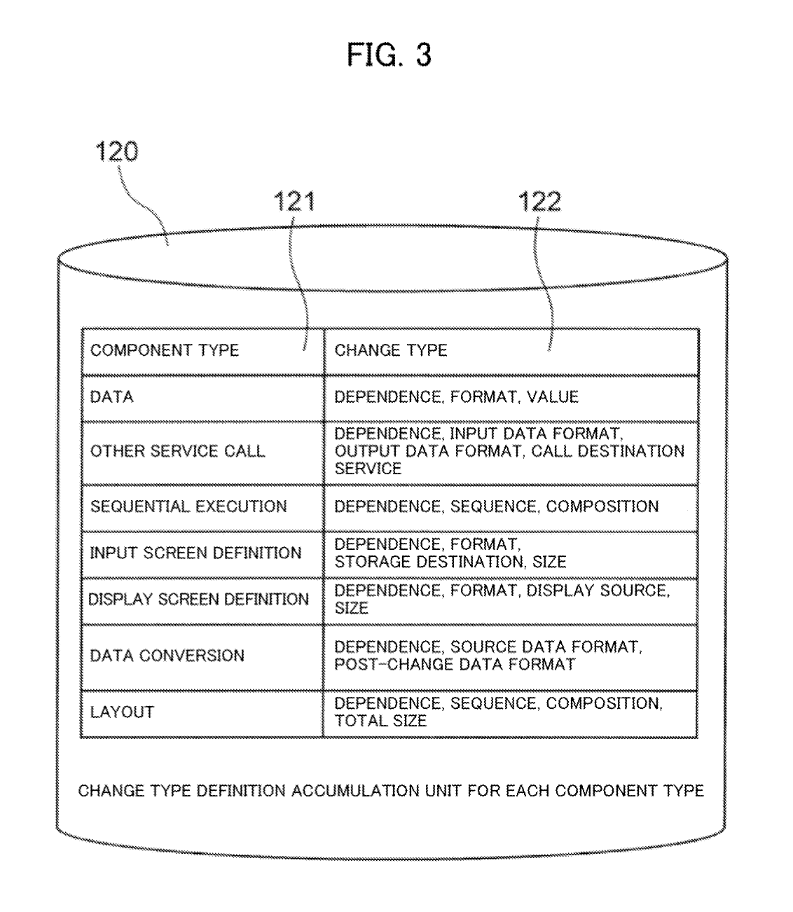

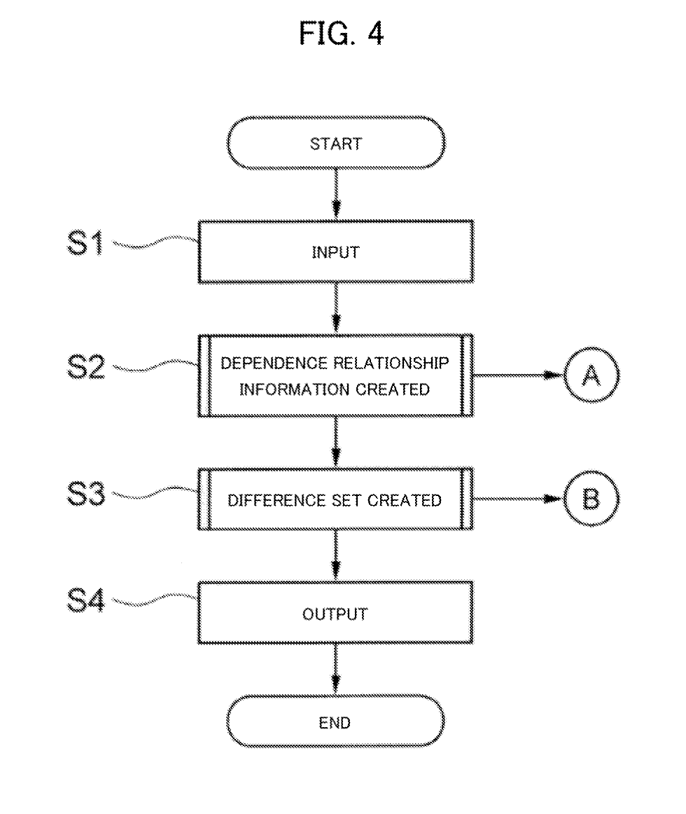

The service change component creation system according to this configuration of the present invention is described in greater detail below. FIG. 2 is a block diagram illustrating an example of the dependence definition database 110 of the database 150 in the service change component generation system 100 of FIG. 1. FIG. 3 is a block diagram illustrating an example of the details of a change type database 120 in this database 150. In addition, FIGS. 4 to 6 are flowcharts showing the sequence of operation processes of this service change component generation system.

As shown in FIG. 2, the dependence definition database 110 stores component types 111, companion component types on which changes in the components of those component types 111 depend, and a table defining the dependence relationships 112 indicating the types of change of those companion components. The dependent companion components shall be called related components in this specification. In this configuration, the information is described by the format “related component types: types of changes in related component types” as the ideal example of the dependence description format.

The definitions illustrated in FIG. 2 are as follows. The component type “other service call” is dependent on the change type “format” of the input component type “data”, and on the change type “format” of the output component type “data”. The component type “next execution” is dependent on change information relating to the post-change data format, original data format, display source and storage destination of each component. The component type “input screen definition” is dependent on the change type “format” of the data format type that is the storage destination. The component type “display screen definition” is dependent on the change type “format” of the data format type that is the display source. The component type “data conversion” is dependent on the change type “format” of the data format type that is the “data conversion” destination and the “data conversion” source. In addition, the component type “layout” is dependent on the change type “component dependences” and the change type “size.” Other services are services that mutually use data, for example between said services.

Referring to FIG. 3, for each component type 121, a table showing the change type 122 defined by that component type 121 is stored in the change type database 120. The definitions shown in FIG. 3 are as follows. The change types “dependence,” “format” and “value” are defined for the component type “data”, and the change types “dependence,” “input data format,” “output data format” and “called service” are defined for the component type “other service call”. The change types “dependence,” “sequence” and “composition” are defined for the component type “sequential execution.” The change types “dependence,” “format,” “storage destination” and “size” are defined for the component type “input screen definition.” The change types “dependence,” “format,” “display source” and “size” are defined for the component type “display screen definition.” The change types “dependence,” “source data format” and “post-change data format” are defined for the component type “data conversion.” The change types “dependence,” “sequence,” “composition” and “total size” are defined for the component type “layout.”

In the table in FIG. 3, the change type “dependence” illustrates that the change regarding whether or not that component type is included in the service is established. Through the change types “format,” “input format,” “output format,” “source data format” and “post-change data format,” the data format that can be stored in the component type “data” is indicated, along with the fact that the data format used when related components are input or output changes. The change types “storage destination” and “display source” indicate that the components where the storage destination of the input results and the source data of the display contents are stored have changed. The change type “sequence” indicates that the component display and execution order change. In addition, the change type “composition” indicates that the composition of the components has changed.

Next, the overall action of this configuration is described in detail with reference to FIGS. 1 to 3 and the flowcharts in FIGS. 4 to 6.

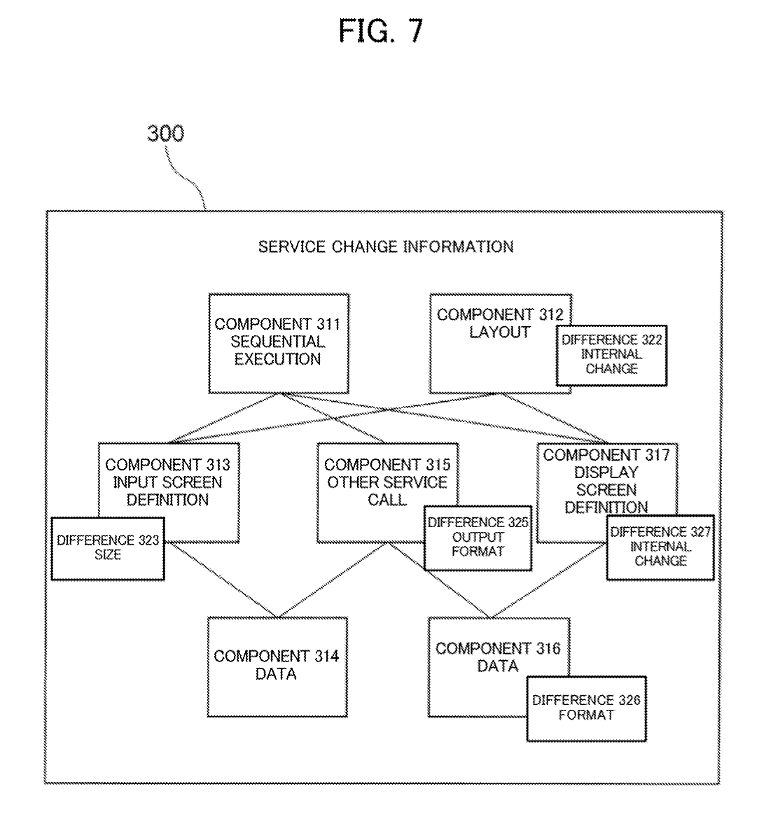

In the process in FIG. 4, the user componentizes changes (change differences) added to a service that includes a plurality of component types using the service change component generation system 100 of the present configuration. When componentizing, first in step S1 of FIG. 1, service change information 300 such as that shown in FIG. 7 is input into the dependence relationship information creation unit 130.

The service change information 300 includes service definitions and component change information. The service definitions are accomplished in accordance with sets of component types comprising the service stored in the dependence definition database 110. In addition, the component change information is defined for each component type in accordance with definitions in the change type database 120. In other words, out of the change types stored in the dependence definition database 110 for each component type comprising the service, what changes occurred or whether there were changes only internally that are not stored in the dependence definition database 110 is recorded in the component change information.

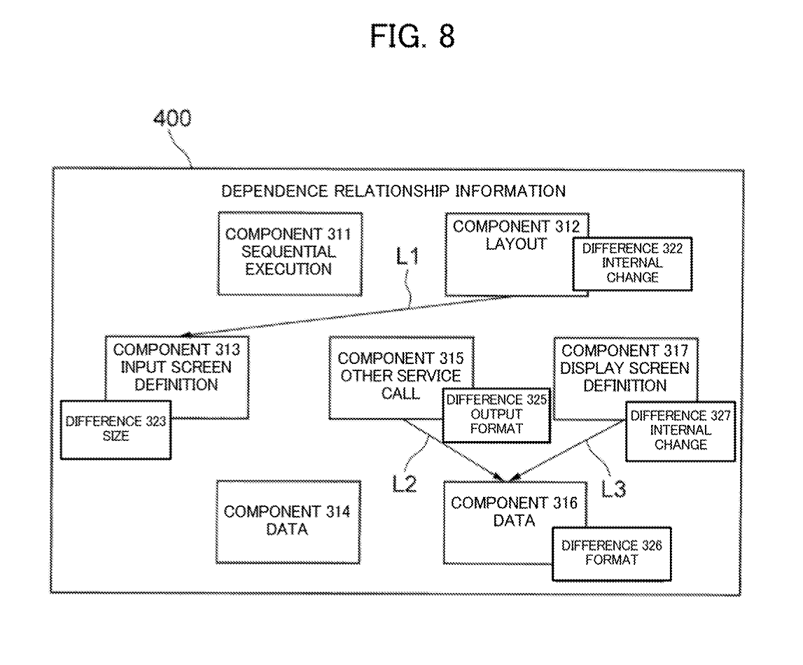

FIG. 7 shows component change information out of the service change information, and links indicating dependence relationships stipulated in FIG. 2 have been appended to that change information. The dependence relationship information creation unit 130 creates a dependence relationship information 400 indicating the dependence relationship for changes in component types comprising the service for the input service change information 300 in accordance with dependence definitions for the component types stored in the dependence definition database 110 (step S2). FIG. 8 shows an example of a dependence relationship information created when the component change information shown in FIG. 7 was input.

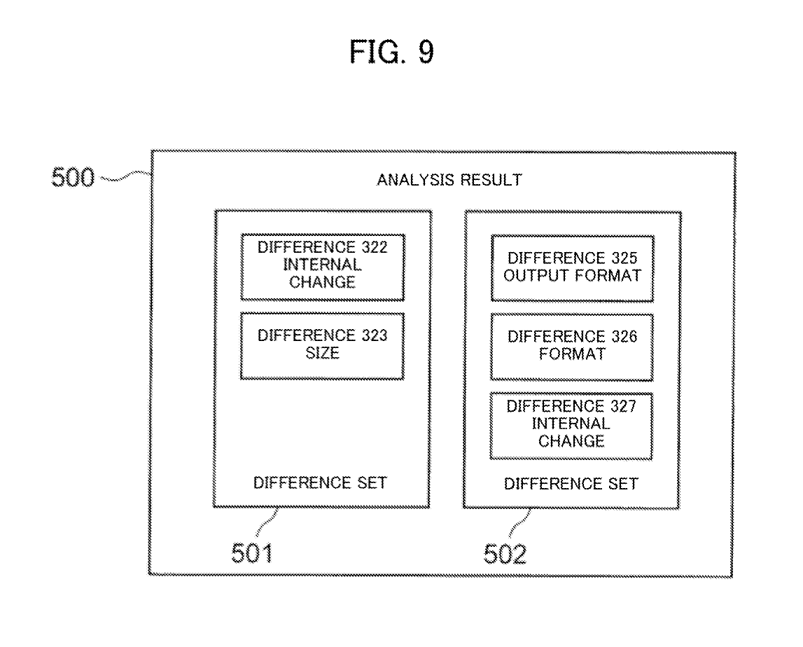

The difference set creation unit 140 creates minimum composition difference sets 501 and 502, as shown in FIG. 9, with reference to the dependence relationship information 400 created by the dependence relationship information creation unit 130 (step S3), and outputs this (step S4). The output difference set is used in changes in other similar services (programs).

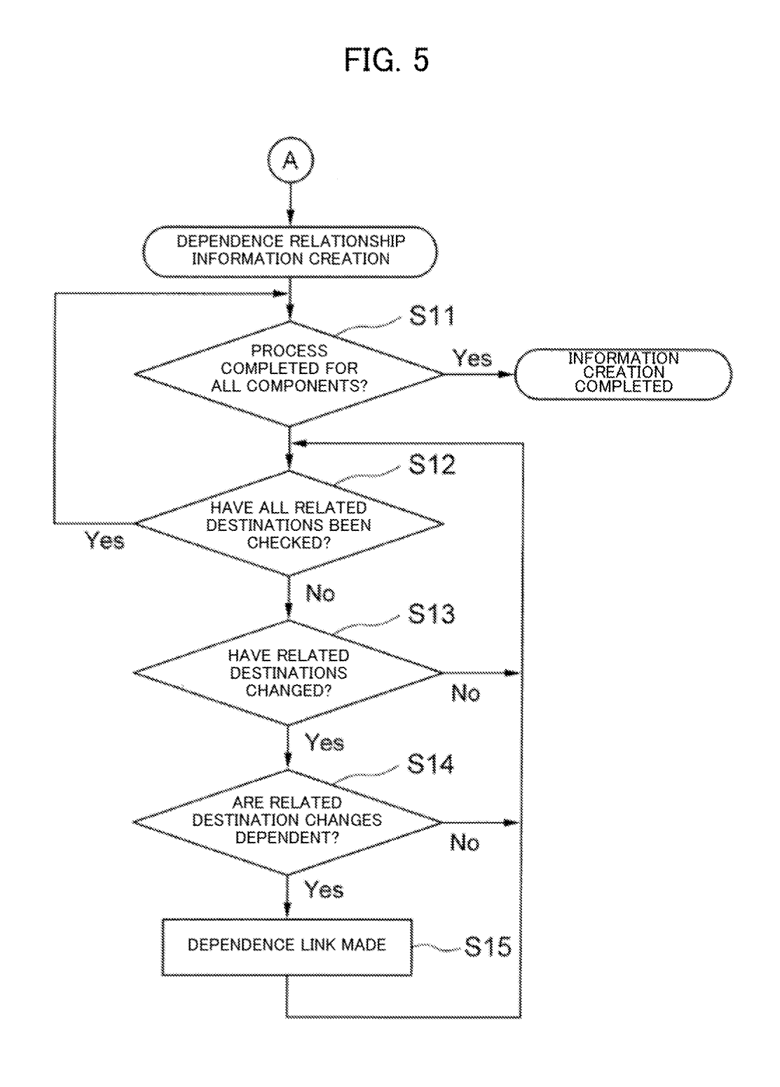

Next, the dependence relationship information creation process in step S2 of FIG. 4 is described in detail with reference to FIGS. 5 through 8. In the process of creating the dependence relationship information 400, processes are accomplished for all component types shown in FIG. 7 (step S11) and the processes are accomplished for the various components and for all related components related to those components (step S12). In FIG. 7, when changes are not applied to the related components of the components in the processes, a determination is made as to whether or not the changes of those related components are changes on which the components in that process are dependent, with reference to the dependence definition database 110 (step S14). When this determination result is that they are changes on which the components in the processes are dependent (Yes in step S14), dependence links L1, L2 and L3 are linked from the components in the processes to the related components (step S15). The above process is repeatedly executed for all components and all related components that constitute the service shown in FIG. 7 (step S11), and the dependence relationship information 400 shown in FIG. 8 is completed.

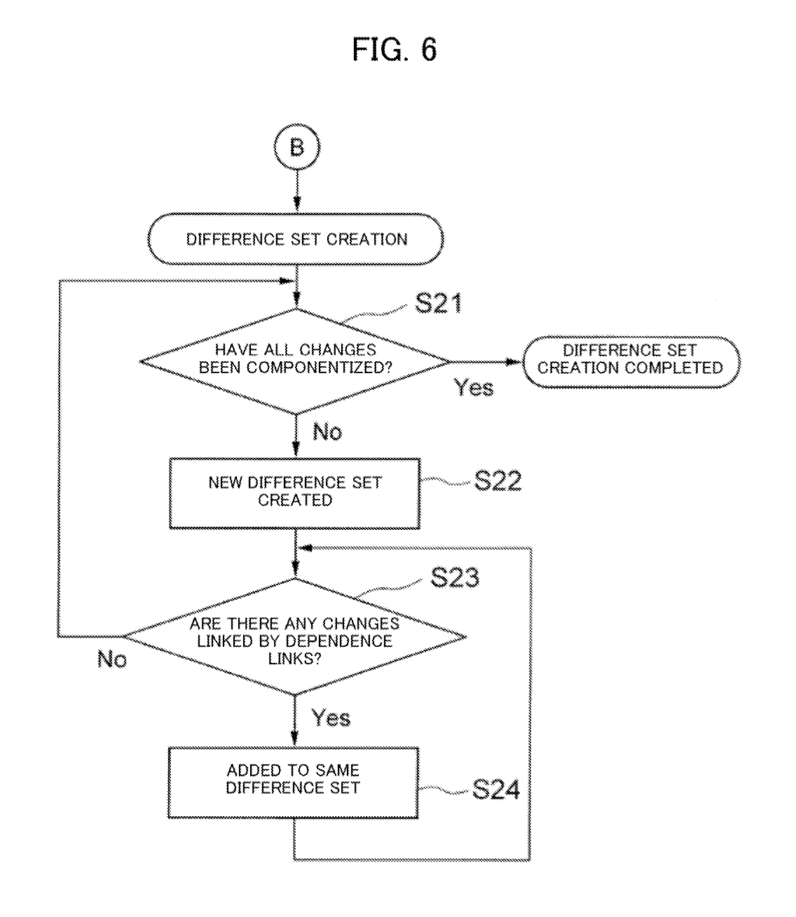

Next, the difference set creation process (step S3 in FIG. 4) is described in detail with reference to FIGS. 6 through 9. The difference set creation process is executed until all of the changes in the dependence relationship are included in one of the difference sets (change component sets) 501 or 502 (step S21), as shown in FIG. 9, with reference to the dependence relationship information 400 that was created (FIG. 8). First, a single change is selected and is added to a new change component set 501 or 502 (step S22). When there is a change linked to the difference set in the process by the dependence links L1, L2 or L3 (step S23), that change is added to the same difference set 501 or 502 (step S24). The above process is executed until all of the changes in the dependence relationships are included in one of the difference sets 501 or 502.

With the present configuration, the dependence definitions of each component type are stored, so it is possible to create a minimum difference set in accordance with the dependence definitions. Consequently, it is possible to create the minimum difference set necessary for strong application coordination, in other words for simultaneous application. Accordingly, it is possible to achieve reusability of the change differences, and as a result it is possible to achieve effective utilization of the service change resource. In this configuration, an example was shown in which the dependence relationship information 400 was created for each component type, but if the input service change information includes dependence information for each component unit, the dependence relationship information 400 may display dependence relationships for each component.

### EMBODIMENT

Next, the action of the above configuration will be described concretely using a concrete embodiment. Suppose the service change information 300 shown in FIG. 7 has been input. The service indicated by the service change information 300 is composed of service components 311 to 317 that comprise the service. The changes indicated by the various service change differences 322, 323, 325, 326 and 327 are applied to the service components 312, 313, 315, 316 and 317. A link defined by FIG. 2 is displayed between components having the possibility of being related to the various components.

In FIG. 7, the component 311 belongs to the “sequential execution” component type, and in this embodiment, components 313, 315 and 317 are related components. The component 312 belongs to the “layout” component type, and in this embodiment, an internal change 322 not appearing in the change type definitions is executed with the components 313 and 317 as related components. The component 313 belongs to the “input screen definition” component type, and in this embodiment, the change 323 of the change type “size” is applied, with the component 314 as a related component. The component 314 indicates a data component type. The component 315 indicates an “other service call” component type, and the change 325 of the “output format” change type is applied, with the components 314 and 316 as related components. The component 316 belongs to the data component type, and change 326 of the “format” change type is applied. In addition, the component 317 belongs to the “display screen definition” component type, and an internal change 327 not appearing in the change type definitions is executed, with the component 316 as the related component.

When the above service change information 300 has been input, the dependence relationship information creation unit 130 creates the dependence information 400 shown in FIG. 8 (step S2 in FIG. 4) with reference to the various definitions stored in the dependence definition database 110. In FIG. 8, dependence links not included in the changes for the actual components have been removed, so only the dependence links L1, L2 and L3 expressing the dependence relationships for the changes of the actually included components are shown.

In the embodiment in FIG. 7, the related component 313 “input screen definition” of the component 312 “layout” has the difference 323 “size” changed. Hence, when the dependence definitions in FIG. 2 stored in the dependence definition database 110 are referenced, the component 312 “layout” is dependent on the change type “size” of the dependent component, so a dependence link L1 is linked with respect to the related component 313 “input screen definition.”

In addition, the related component 317 “display screen definition” of the component 312 “layout” is changed by the difference 327 “internal change.” Hence, when the dependence definitions stored in the dependence definition database 110 are referenced, the component 312 “layout” does not exist in the change “internal change” of the related component 317 “display screen definition.” Consequently, a dependence link is not made to the related component 317 “display screen definition” from the component 312 “layout.”

Similarly, the related component 316 “data” of the component 315 “other service call” is changed by the difference 326 “format.” Hence, when the dependence definitions stored in the dependence definition database 110 are referenced, the component 315 “other service call” is dependent on the change “format” of the input/output data, so a dependence link L2 is made to the related component 316 “data” from the component 315 “other service call.”

Similarly, the related component 316 “data” of the component 317 “display screen definition” is changed by the difference 326 “format.” Hence, when the dependence definitions stored in the dependence definition database 110 are referenced, the component 317 “display screen definition” is dependent on the change “format” of the display source data, so a dependence link L3 is made to the related component 316 “data” from the component 317 “display screen definition.”

Next, the difference set creation unit 140 executes step S3 in FIG. 4 on the basis of the dependence relationship information 400, analyzes the dependence relationships and creates and outputs the change component sets 501 and 502 shown in FIG. 9 as the analysis results 500. The change component set 501 includes the difference 322 “internal change” in the component 312 “layout” and the difference 323 in the component 313 “input screen definition,” and shows that the difference 322 and the difference 323 are a series of changes. Similarly, the change component set 502 includes the difference 325 in the component 315 “other service call,” the difference 326 in the component 316 “data” and the difference 327 in the component 317 “display screen definition,” and shows that the difference 325, the difference 326 and the difference 327 are a series of changes.

As described above, by creating the difference set components, it is possible to use change information inside one service in changes inside similar other services. Consequently, it is possible to achieve reuse of change information, making it possible to achieve effective utilization of service change resources.

The component types 111 stored in the dependence definition database 110 in the above-described configuration is one example of a component type comprising a service. The service change component creation system of the present invention is not limited to the component types 111 shown in FIG. 2, and may store only a portion of these. In addition, other component types may be defined, appended and stored. Furthermore, the dependence relationships 112 in FIG. 2 are the ideal dependence relationships for each of the component types, but dependence relationships other than this may be defined and stored.

Similarly, the component type 121 stored in the change type database 120 is one example of the component types comprising the service. The service change component creation system of the present invention is not limited to the component types 121 shown in FIG. 3, and may store only a portion of these. In addition, other component types may be defined, appended and stored. Furthermore, the change types 122 shown in FIG. 3 are one example for each component type, and change types other that this may also be defined and stored.

The present invention was described with reference to an exemplary configuration especially illustrating the present invention, but the present invention is not limited to that configuration or variations thereof. As is clear to one skilled in the art, various variations of the present invention are possible without departing from the spirit or scope of the present invention stipulated by the appended Scope of Claims.

This application claims the benefit of Japanese Patent Application 2008-107354, filed Apr. 16, 2008, the entire disclosure of which is incorporated by reference herein.

### INDUSTRIAL APPLICABILITY

The present invention can be applied to a service development foundation applying changes in one service to other services.

1. A service change component generation system comprising:
a dependence relationship information creation unit that, when service change information including information specifying a component to be changed out of a plurality of components in inputted, creates dependence relationship information between components to be changed in a service by referring to a database storing dependence relationship definitions indicating dependence relationships between change of a component and change of related components; and
a changing component set creation unit that refers to the dependence relationship information, extracts changing components mutually related by the dependence relationships and creates a changing components set.

2. The service change component generation system according to claim 1, wherein the service change information includes change difference information in the changing components and the changing components set includes difference information for changing components.

3. The service change component generation system according to claim 1, wherein the dependence relationship definitions include definitions between types of targeted components and types of related components related to these targeted components.

4. The service change component generation system according to claim 3, wherein the dependence relationship definitions include definitions for each change type of the targeted components and the related components.

5. The service change component generation system according to claim 1, wherein the dependence relationship information includes links linking components having dependence relationships.

6. A service change component creation method for:
inputting service change information including information specifying a component to be changed out of a plurality of components;
creating information on dependence relationships among changing components in the service by referring to a database storing dependence relationship definitions showing dependence relationships between component changes and related component changes; and
creating a changing component set by referring to the dependence relationship information and extracting changing components that are mutually related by the dependence relationships.

7. The service change component creation method according to claim 6, wherein the service change information includes change difference information in the changing components and the changing components set includes difference information for changing components.

8. The service change component creation method according to claim 6, wherein the dependence relationship definitions include definitions between types of targeted components and types of related components related to these targeted components.

9. The service change component creation method according to claim 8, wherein the dependence relationship definitions include definitions for each change type of the targeted components and the related components.

10. The service change component creation method according to claim 6, wherein the dependence relationship information includes links linking components having dependence relationships.

11. A recording medium for recording a program readable and writable by a computer, wherein this program causes the computer to execute:
a process for inputting service change information including information specifying a component to be changed out of a plurality of components;
a process for creating information on dependence relationships among changing components in the service by referring to a database storing dependence is relationship definitions showing dependence relationships between component changes and related component changes; and
a process for creating a changing component set by referring to the dependence relationship information and extracting changing components that are mutually related by the dependence relationships.

12. The recording medium according to claim 11, wherein the service change information includes change difference information in the changing components and the changing components set includes difference information for changing components.

13. The recording medium according to claim 11, wherein the dependence relationship definitions include definitions between types of targeted components and types of related components related to these targeted components.

14. The recording medium according to claim 13, wherein the dependence relationship definitions include definitions for each change type of the targeted components and the related components.

15. The recording medium according to claim 11, wherein the dependence relationship information includes links linking components having dependence relationships.
